(19) United States
(12) Patent Application Publication
(10) Pub. No.: US 2023/0013718 A1
(43) Pub. Date: Jan. 19, 2023

(54) UNCERTAINTY-AWARE FEDERATED LEARNING METHODS AND SYSTEMS IN MOBILE EDGE COMPUTING NETWORK

(71) Applicant: Dalian University of Technology, Dalian (CN)

(72) Inventors: Zichuan Xu, Dalian (CN); Qiufen Xia, Dalian (CN); Dongrui Li, Dalian (CN)

(21) Appl. No.: 17/497,977

(22) Filed: Oct. 11, 2021

(30) Foreign Application Priority Data
Jun. 7, 2021 (CN) 202110629960.4

(51) Int. Cl. G06N 20/00; G06N 5/02

(52) U.S. Cl. CPC G06N 20/00; G06N 5/027

(57) ABSTRACT

Uncertainty-ware federated learning methods and systems in a mobile edge computing network can include defining an average volume of a training parameter of each user equipment under an uncertainty of a mobile edge computing network based on a federated learning framework; determining an average model size factor and the minimum and maximum number of aggregators during each federated learning task request; determining the number of aggregators; constructing an auxiliary graph, and determining a location decision according to the auxiliary graph; determining a total cost during each federated learning task request according to the location decision; adjusting the number of aggregators according to the total cost with a resource capacity of the mobile edge computing network as a constraint to obtain the decision including aggregator placement, user equipment assignment and the optimal number of aggregators during each federated learning task request, and optimizing the federated learning framework.

### CROSS-REFERENCE TO RELATED APPLICATION(S)

This patent application claims the benefit and priority of Chinese Patent Application No. 202110629960.4 filed on Jun. 7, 2021. The '960.4 application is incorporated by reference herein in its entirety.

### FIELD OF THE INVENTION

The present disclosure relates to the field of mobile edge computing (MEC) network communications, and in particular, to uncertainty-aware federated learning (FL) methods and systems in MEC networks.

With the rapid development of 5G and MEC, a variety of artificial intelligence (AI) applications, such as augmented reality (AR) and intelligent healthcare, are being deployed in MEC networks. As these AI applications generate a large amount of data continuously in the MEC networks, there is a need to analyze the data to improve the accuracy. In at least some embodiments, the data are conventionally trained on a centralized location (i.e., a data center) where a powerful graphics processing unit (GPU) is provided, and all data from each user equipment (UE) are transmitted to the centralized location. However, sending all the original data (with sensitive data, i.e., facial images of users) to the centralized location can infringe users' privacies. FL is envisioned as a promising technology to avoid the privacy breaches of UEs, by training local data in the UE. Training parameters in each UE are transmitted to a centralized location to merge with parameters of other UEs, thereby obtaining a global machine learning model. As AI applications generate the data in edge locations, MEC is a natural technology to implement the cost-sensitive FL.

Due to completely distributed computing resources and network uncertainties, the use of FL in MEC networks is challenging. Specifically, 5G base stations (BSs) with millimeter wave communications are densely deployed to ensure a full coverage for the UEs. This dense deployment adds a new level of dynamic performance and network uncertainty making implementing FL requests more complicated. Because of the small coverage areas of the 5G BSs, the UEs can be registered to different BSs within a short time, which means that the arrival patterns of FL request is uncertain. At this time, if the UEs have available resources, intermittent local training is performed. In addition, prior to implementation of the FL request, each FL service can have an uncertain parameter size due to the unknown neural network model, such that the placement of aggregators is complicated. If the aggregators are placed upon the arrival of the request, the overhead of a certain MEC network can be out of control due to delay or other reasons, and it is unpractical to place the aggregators for continuous FL requests of different models. Therefore, it is vital to pre-place the aggregators in order to process the transmitted request timely in case of the uncertain parameter size.

Also, according to the requirements of the BSs on resource capacities in the dense 5G MEC networks, the aggregators can be carefully placed to multiple edge locations. Specifically, limited computing resources such as field programmable gate arrays and neural network accelerators can be added to the 5G BSs. In these cases, FL services may not be put into a single BS. As a trained model needs to be sent out for aggregation, the performance of such a layout depends on communication and processing costs.

In addition to the careful placement of the aggregators, the implementation of the FL service further depends on the appropriate number of aggregators. If fewer aggregators are used in the FL service, although the processing cost can be saved, the communication cost can be high since the users will send trained models to the aggregators through longer paths. Therefore, it is desirable to find the appropriate number of aggregators for each FL service.

### SUMMARY OF THE INVENTION

An objective of at least some embodiments of the present disclosure is to provide uncertainty-aware FL methods and systems in MEC networks, to solve the problems, such as minimizing, or at least reducing, the implementation cost through joint aggregator placement and UE assignment under an uncertainty of a MEC network. An objective of at least some embodiments of the is to find the appropriate number of aggregators for each FL request.

To implement the above objectives, the present disclosure provides the following solutions:

An uncertainty-aware FL method in an MEC network can include: defining an average volume of a training parameter of each UE under an uncertainty of an MEC network based on an FL framework, the uncertainty of the MEC network being an uncertainty of a transmitted model parameter; determining an average model size factor during each FL task request according to the average volume of the training parameter of each UE; determining the minimum number of aggregators and the maximum number of aggregators during each FL task request according to the average model size factor; determining a number of aggregators according to the minimum number of aggregators and the maximum number of aggregators; constructing an auxiliary graph according to the number of aggregators, and determining a location decision according to the auxiliary graph, the location decision including UE assignment, aggregator placement and service placement; determining a total cost during each FL task request according to the aggregator placement and UE assignment decision with the number of aggregators; and adjusting the number of aggregators according to the total cost with a resource capacity of the MEC network as a constraint to obtain the decision including aggregator placement and UE assignment and the optimal number of aggregators during each FL task request, and optimizing the FL framework according to the optimal number of aggregators, thereby minimizing, or at least reducing, the total cost.

In some embodiments, determining an average model size factor during each FL task request according to the average volume of the training parameter of each UE can include: discretizing a range of the average model size factor into any interval of a fixed length according to the average volume of the training parameter of each UE; determining a finite value set of the average model size factor according to the fixed length; determining an active value set of the average model size factor according to the finite value set by using a greedy algorithm of a multi-armed bandit (MAB); and determining the average model size factor according to the active value set.

In some embodiments, determining the minimum number of aggregators and the maximum number of aggregators during each FL task request according to the average model size factor can include: determining the minimum number of aggregators with

$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ Lo {c}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ Lo {c}_{q} \}} \} ,$$

where, n^{min} is the minimum number of aggregators; γ_{q} is a quantity of computing resources assigned to aggregate a unit data volume on the location Loc_{q}; χ is the average model size factor; μ(|wₘ|) is the average volume of the training parameter of each UE; |wₘ| is a size of a transmission model between the UE and its service Sₘ; μεₘ is a UE set of the FL service m; Loc_{q} is one first potential location of a cloudlet (CL) or a BS; Cq is a computing resource capacity on the location Loc_{q}; δ_{q} is a quantity of bandwidth resources assigned to transmit unit data on the location Loc_{q}; and B_{q} is a bandwidth resource capacity on the location Loc_{q}.

In some embodiments, determining the number of aggregators according to the minimum number of aggregators and the maximum number of aggregators can include determining the number of aggregators within a present range according to the minimum number of aggregators and the maximum number of aggregators by using a binary search, the present range being an ever-changing range during the binary research.

In some embodiments, constructing an auxiliary graph according to the number of aggregators, and determining a location decision according to the auxiliary graph can include: constructing the auxiliary graph according to the number of aggregators, and setting a cost and a capacity of each edge within the auxiliary graph; taking the training parameter of each UE as a demanded commodity, and determining a demand for commodities of training parameters in each FL request according to the average model size factor; determining a splittable flow from a source to a sink node for each UE from the auxiliary graph based on the demand for the commodities, the splittable flow being a multi-commodity flow; determining, according to the splittable flow, a probability that the UE is assigned to the BS, a probability that the aggregator is placed to the Loc_{q} and a probability that the service is placed to the Loc_{q}, the Loc_{q} being the first potential location of the CL or the BS; determining, according to the probability that the UE is assigned to the BS, the probability that the aggregator is placed to the Loc_{q} and the probability that the service is placed to the Loc_{q}, a location where the UE is randomly assigned to the BS, a location where the aggregator is randomly placed to the Loc_{q} and a location where the service is randomly placed; moving, according to the location where the UE is randomly assigned to the BS, each splittable flow of the UE to a randomly selected BS on a UE and BS layer of the auxiliary graph; moving, according to the location where the aggregator is randomly placed to the Loc_{q}, each splittable flow of the UE to a minimum-cost aggregator on the aggregator layer of the auxiliary graph; moving, according to the location where the service is randomly placed, on a service layer of the auxiliary graph, each splittable flow of the UE to a location where the service is located; and determining an unsplittable flow according to the splittable flow, and converting the unsplittable flow into the location decision including the UE assignment, the aggregator placement and the service placement, a node path through which the unsplittable flow passes being a decision-making result of the location decision.

In some embodiments, the probability that the UE is assigned to the BS is

$${p}_{k , i} = \frac{{f}_{k} ( b {s}_{i} )}{2 \cdot {f}_{k}}$$

where, p_{k,i} is the probability that the UE is assigned to the BS; fₖ(bsᵢ) is a flow passing through an edge between the UE and the BS on the UE and BS layer of the auxiliary graph; and fₖ is the flow obtained by the UE; the aggregator layer provides a potential location of the aggregator for the FL request; nₘ widgets W_{m,o} are created, with each widget corresponding to a potential location set of an aggregator A_{m,o}; a potential location having a sufficient available resource is added to a widget W_{m,o} to complete an aggregation task of the aggregator A_{m,o}; and a second potential location Loc′_{q} is created, the second potential location Loc′_{q} being a virtual location node, and the Loc′_{q} and the Loc_{q} are added to a widget together; the probability that the aggregator is placed to the Loc_{q} is

$${p}_{m , o , q} = \frac{{\sum }_{u {e}_{k} ∈ U E} {f}_{k} ( {Loc}_{q} , {W}_{m , o} )}{2 \cdot {\sum }_{{Loc}_{{q}^{′}} ∈ BS ⋃ CL , {ue}_{k} ∈ U E} {f}_{k} ( {Loc}_{{q}^{′}} , {W}_{m , o} )}$$

where, p_{m,o,q} is the probability that the aggregator is placed to the Loc_{q}; ueₖ is any UE; all UEs are collectively called the UE; W_{m,o} is the widget of the aggregator A_{m,o}; Loc_{q′} is the second potential location; BS is a set of small-cell base stations; CL is a set of cloudlets; fₖ(Loc_{q},W_{m,o}) is a flow routed by the widget W_{m,o} through an edge <Loc_{q}, Loc′_{q}> in the auxiliary graph; Σᵤₑ_{ₖ}_{∈UE}fₖ(Loc_{q},W_{m,o}) is a total routing flow of the widget W_{m,o} placed on one Loc_{q} location through the aggregator A_{m,o}; and Σ_{Loc′}_{_{q}}_{∈BS∪CL,ue}_{ₖ}_{∈UE}fₖ(Loc_{q′}, W_{m,o}) is a total routing flow of the widget W_{m,o} placed on all potential locations through the aggregator A_{m,o}; the service layer provides two virtual nodes LOC″_{q} and LOC″′_{q} for each first potential location Loc_{q} and service Sₘ, the Loc″_{q} being a third potential location, and the Loc′″_{q} being a fourth potential location; and every two Loc′_{q} and Loc′″_{q} are added to a new widget for the service Sₘ; and the probability that the service placed to the Loc_{q} is:

$${p}_{m , q} = \frac{{\sum }_{u {e}_{k} ∈ U E} {f}_{k} ( L o {c}_{q ′} {S}_{m} )}{2 \frac{\vert {w}_{max} \vert}{{d}_{unit}} \cdot {\sum }_{L o {c}_{q ′} ∈ BS ⋃ CL , u {e}_{k} ∈ U E} {f}_{k} ( L o {c}_{{q}^{′}} , {S}_{m} )}$$

where, p_{m,q} is the probability that the service is placed to Loc_{q}; fₖ(Loc_{q}, Sₘ) is a flow routed through an edge <Loc″_{q},Loc′″_{q}> in the auxiliary graph; Σᵤₑ_{ₖ}_{∈UE}fₖ(Loc_{q}, Sₘ) is a total routing flow of placement on one Loc_{q} location through the service Sₘ; and Σ_{Loc′}_{_{q}}_{∈BS∪CL,ue}_{ₖ}_{∈UE}fₖ(Loc_{q′}, Sₘ) is a total routing flow of placement on all potential locations through the service Sₘ.

In some embodiments, determining a total cost during each FL task request according to the aggregator placement and UE assignment decision with the number of aggregators can include: determining the total cost during each FL task request with an Eq. cost(n)=cₖ^{l}+n·c_{k,m,o}^{t}+n·c_{m,o}^{t}+cₘ^{a}, where, cost(n) is the total cost during the FL task request using n aggregators, n being the number of aggregators; cₖ^{l} is a calculation cost of the UE for locally training a dataset; c_{k,m,o}^{t} is a communication cost of uploading of the UE ueₖ to one aggregator A_{m,o} in the service Sₘ; c_{m,o}^{t} is a communication cost for uploading a model from one aggregator to a master aggregator in the service Sₘ; and cₘ^{a} is a cost of parameter aggregation during the FL task request.

In some embodiments, an uncertainty-aware FL system in an MEC network can include: a module for defining an average volume of a training parameter configured to define an average volume of a training parameter of each UE under an uncertainty of an MEC network based on an FL framework, the uncertainty of the MEC network being an uncertainty of a transmitted model parameter; an average model size factor determination module configured to determine an average model size factor during each FL task request according to the average volume of the training parameter of each UE; a module for determining the minimum number of aggregators and the maximum number of aggregators configured to determine the minimum number of aggregators and the maximum number of aggregators during each FL task request according to the average model size factor; a module for determining the number of aggregators configured to determine the number of aggregators according to the minimum number of aggregators and the maximum number of aggregators; a location decision determination module configured to construct an auxiliary graph according to the number of aggregators, and determine a location decision according to the auxiliary graph, the location decision including UE assignment, aggregator placement and service placement; a total cost determination module configured to determine a total cost during each FL task request according to the location decision and the number of aggregators; and an adjustment module configured to adjust the number of aggregators according to the total cost with a resource capacity of the MEC network as a constraint to obtain the decision including aggregator placement and UE assignment and the optimal number of aggregators during each FL task request, and optimize the FL framework according to the optimal number of aggregators, thereby minimizing, or at least reducing, the total cost.

In some embodiments, the average model size factor determination module can include: a discretization unit configured to discretize a range of the average model size factor into any interval of a fixed length according to the average volume of the training parameter of each UE; a finite value set determination unit configured to determine a finite value set of the average model size factor according to the fixed length; an active value set determination unit configured to determine an active value set of the average model size factor according to the finite value set by using a greedy algorithm of an MAB; and an average model size factor determination unit configured to determine the average model size factor according to the active value set.

In some embodiments, the module for determining the minimum number of aggregators and the maximum number of aggregators may specifically include: a unit for determining the minimum number of aggregators configured to determine the minimum number of aggregators with

$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ Lo {c}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ Lo {c}_{q} \}} \} ,$$

wherein, n^{min} is the minimum number of aggregators; γ_{q} is a quantity of computing resources assigned to aggregate a unit data volume on the location Loc_{q}; χ is the average model size factor; μ(|wₘ|) is the average volume of the training parameter of each UE; |wₘ| is a size of a transmission model between the UE and its service Sₘ; μεₘ is a UE set of the FL service m; Loc_{q} is one first potential location of a CL or a BS; Cq is a computing resource capacity on the location Loc_{q}; δ_{q} is a quantity of bandwidth resources assigned to transmit unit data on the location Loc_{q}; and B_{q} is a bandwidth resource capacity on the location Loc_{q}; a unit for determining the maximum number of aggregators configured to acquire the number of UEs.

Based on the specific embodiments provided, the present disclosure discloses the following technical effects: For problems on aggregator placement and UE assignment during a single FL task request in the MEC network, the uncertainty-aware FL methods and systems in MEC networks provided by the present disclosure define an average volume of a training parameter of each UE under an uncertainty of a MEC network based on an FL framework, determine an average model size factor during each FL task request, determine the appropriate number of aggregators according to the average model size factor, construct an auxiliary graph, reasonably arrange locations of the aggregators and the number of aggregators based on the auxiliary graph, adjust the number of aggregators with a resource capacity of the MEC network as a constraint to obtain the decision including aggregator placement and UE assignment and the optimal number of aggregators during each FL task request, and optimize the FL framework according to the optimal number of aggregators, thereby minimizing, or at least reducing, a total cost.

### BRIEF DESCRIPTION OF THE DRAWINGS

FIG. 1 is a flow chart of an uncertainty-aware FL method in an MEC network.

FIG. 2 is a schematic view of an FL framework.

FIG. 3 is an auxiliary graph.

FIG. 4 is a structural view of an uncertainty-aware FL system in an MEC network.

### DETAILED DESCRIPTION OF ILLUSTRATIVE EMBODIMENTS

The technical solutions of the embodiments of the present disclosure are described below with reference to the accompanying drawings. The described embodiments are merely a part rather than all of the embodiments of the present disclosure. All other embodiments obtained by the person of ordinary skill in the art based on the embodiments of the present disclosure fall within the protection scope of the present disclosure.

To make the foregoing objectives, features, and advantages of the present disclosure clearer and more comprehensible, the present disclosure is now further described in detail below in conjunction with the accompanying drawings and specific embodiments.

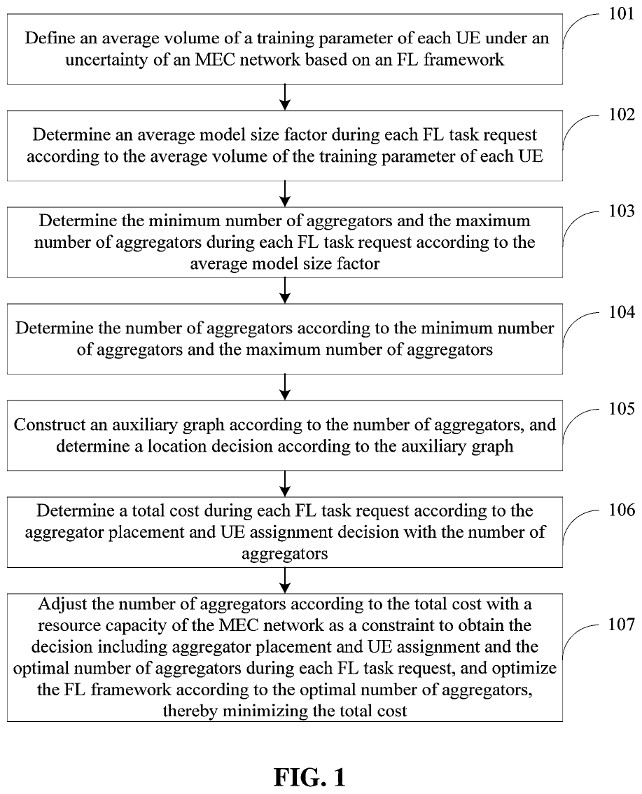

FIG. 1 is a flow chart of an uncertainty-aware FL method in an MEC network according to the present disclosure. As shown in FIG. 1, the uncertainty-aware FL method in an MEC network can include the following steps:

Step 101: Define an average volume of a training parameter of each UE under an uncertainty of an MEC network based on an FL framework, the uncertainty of the MEC network being an uncertainty of a transmitted model parameter.

Step 102: Determine an average model size factor during each FL task request according to the average volume of the training parameter of each UE.

In application, Step 102 can specifically include: Discretizing a range of the average model size factor into any interval of a fixed length according to the average volume of the training parameter of each UE; determine a finite value set of the average model size factor according to the fixed length; determine an active value set of the average model size factor according to the finite value set by using a greedy algorithm of an MAB; and determine the average model size factor according to the active value set.

Step 103: Determine the minimum number of aggregators and the maximum number of aggregators during each FL task request according to the average model size factor.

In actual applications, Step 103 can specifically include: Determining the minimum number of aggregators with

$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ Lo {c}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ Lo {c}_{q} \}} \} ,$$

where, n^{min} is the minimum number of aggregators; γ_{q} is a quantity of computing resources assigned to aggregate a unit data volume on the location Loc_{q}; χ is the average model size factor; μ(|wₘ|) is the average volume of the training parameter of each UE; |wₘ| is a size of a transmission model between the UE and its service Sₘ; μ∈ₘ is a UE set of the FL service m; Loc_{q} is one first potential location of a CL or a BS; Cq is a computing resource capacity on the location Loc_{q}; δ_{q} is a quantity of bandwidth resources assigned to transmit unit data on the location Loc_{q}; and B_{q} is a bandwidth resource capacity on the location Loc_{q}.

Step 104: Determine the number of aggregators according to the minimum number of aggregators and the maximum number of aggregators.

In actual applications, Step 104 can specifically include: Determining the number of aggregators within a present range according to the minimum number of aggregators and the maximum number of aggregators by using a binary search, the present range being an ever-changing range during the binary research.

Step 105: Construct an auxiliary graph according to the number of aggregators, and determine a location decision according to the auxiliary graph, the location decision including UE assignment, aggregator placement and service placement.

In actual applications, Step 105 can specifically include: Constructing the auxiliary graph according to the number of aggregators, and setting a cost and a capacity of each edge within the auxiliary graph; taking the training parameter of each UE as a demanded commodity, and determining a demand for commodities of training parameters in each FL request according to the average model size factor; determining a splittable flow from a source to a sink node for each UE from the auxiliary graph based on the demand for the commodities, the splittable flow being a multi-commodity flow; determining, according to the splittable flow, a probability that the UE is assigned to the BS, a probability that the aggregator is placed to the Loc_{q} and a probability that the service is placed to the Loc_{q}, the Loc_{q} being the first potential location of the CL or the BS; determine, according to the probability that the UE is assigned to the BS, the probability that the aggregator is placed to the Loc_{q} and the probability that the service is placed to the Loc_{q}, a location where the UE is randomly assigned to the BS, a location where the aggregator is randomly placed to the Loc_{q} and a location where the service is randomly placed; movong, according to the location where the UE is randomly assigned to the BS, each splittable flow of the UE to a randomly selected BS on a UE and BS layer of the auxiliary graph; moving, according to the location where the aggregator is randomly placed to the Loc_{q}, each splittable flow of the UE to a minimum-cost aggregator on the aggregator layer of the auxiliary graph; moving, according to the location where the service is randomly placed, on a service layer of the auxiliary graph, each splittable flow of the UE to a location where the service is located; and determining an unsplittable flow according to the splittable flow, and converting the unsplittable flow into the location decision including the UE assignment, the aggregator placement and the service placement, a node path through which the unsplittable flow passes being a decision-making result of the location decision.

The probability that the UE is assigned to the BS is:

$${p}_{k , i} = \frac{{f}_{k} ( {bs}_{i} )}{2 \cdot {f}_{k}}$$

where, p_{k,i} is the probability that the UE is assigned to the BS; fₖ(bsᵢ) is a flow passing through an edge between the UE and the BS on the UE and BS layer of the auxiliary graph; and fₖ is the flow obtained by the UE.

The aggregator layer provides a potential location of the aggregator for the FL request; nₘ widgets W_{m,o} are created, with each widget corresponding to a potential location set of an aggregator A_{m,o}; a potential location having a sufficient available resource is added to a widget W_{m,o} to complete an aggregation task of the aggregator A_{m,o}; and a second potential location LOC′_{q} is created, the second potential location Loc′_{q} being a virtual location node, and the Loc′_{q} and the Loc_{q} are added to a widget together.

The probability that the aggregator is placed to the Loc_{q} is:

$${p}_{m , o , q} = \frac{{\sum }_{{ue}_{k} ∈ UE} {f}_{k} ( {Loc}_{q} , {W}_{m , o} )}{2 \cdot {\sum }_{{Loc}_{{q}^{′}} ∈ BS ⋃ CL , {ue}_{k} ∈ UE} {f}_{k} ( {Loc}_{{q}^{′}} , {W}_{m , o} )}$$

where, p_{m,o,q} is the probability that the aggregator is placed to the Loc_{q}; ueₖ is any UE; all UEs are collectively called the UE; W_{m,o} is the widget of the aggregator A_{m,o}; Loc_{q′} is the second potential location; BS is a set of small-cell base stations; CL is a set of cloudlets; fₖ(Loc_{q},W_{m,o}) is a flow routed by the widget W_{m,o} through an edge <Loc_{q},Loc′_{q}> in the auxiliary graph; Σᵤₑ_{ₖ}_{∈UE}fₖ(Loc_{q}, W_{m,o}) is a total routing flow of the widget W_{m,o} placed on one Loc_{q} location through the aggregator A_{m,o}; and Σ_{Loc′}_{_{q}}_{∈BS∪CL,ue}_{ₖ}_{∈UE}fₖ(Loc_{q′}, W_{m,o}) is a total routing flow of the widget W_{m,o} placed on all potential locations through the aggregator A_{m,o}.

The service layer provides two virtual nodes Loc″_{q} and Loc′″_{q} for each first potential location Loc_{q} and service Sₘ, the Loc″_{q} being a third potential location, and the Loc′″_{q} being a fourth potential location; and every two Loc′_{q} and Loc′″_{q} are added to a new widget for the service Sₘ.

The probability that the service placed to the Loc_{q} is:

$${p}_{m , q} = \frac{{\sum }_{{ue}_{k} ∈ UE} {f}_{k} ( {Loc}_{q} , {S}_{m} )}{2 \frac{\vert {w}_{max} \vert}{{d}_{unit}} \cdot {\sum }_{L o {c}_{{q}^{′}} ∈ BS ⋃ CL , {ue}_{k} ∈ UE} {f}_{k} ( {Loc}_{{q}^{′}} , {S}_{m} )}$$

where, p_{m,q} is the probability that the service is placed to Loc_{q};fₖ(Loc_{q},Sₘ) is a flow routed through an edge <Loc′_{q}, Loc′″_{q} > in the auxiliary graph; Σᵤₑ_{ₖ}_{∈UE}fₖ(Loc_{q}, Sₘ) is a total routing flow of placement on one Loc_{q} location through the service Sₘ; and Σ_{Loc′}_{_{q}}_{∈BS∪CL,ue}_{ₖ}_{∈UE}fₖ(Loc_{q′}, Sₘ) is a total routing flow of placement on all potential locations through the service Sₘ.

Step 106: Determine a total cost during each FL task request according to the aggregator placement and UE assignment decision with the number of aggregators.

In actual applications, Step 106 can specifically include: Determining the total cost during each FL task request with an Eq. cost(n)=cₖ^{l}+n. c_{k,m,o}^{t}+n·c_{m,o}^{t}+cₘ^{a}, where, cost(n) is the total cost during the FL task request using n aggregators, n being the number of aggregators; cₖ^{l} is a calculation cost of the UE for locally training a dataset; c_{k,m,o}^{t} is a communication cost of uploading of the UE ueₖ to one aggregator A_{m,o} in the service Sₘ; c_{m,o}^{t} is a communication cost for uploading a model from one aggregator to a master aggregator in the service Sₘ; and cₘ^{a} is a cost of parameter aggregation during the FL task request.

Step 107: Adjust the number of aggregators according to the total cost with a resource capacity of the MEC network as a constraint to obtain the decision including aggregator placement and UE assignment and the optimal number of aggregators during each FL task request, and optimize the FL framework according to the optimal number of aggregators, thereby minimizing, or at least reducing, the total cost.

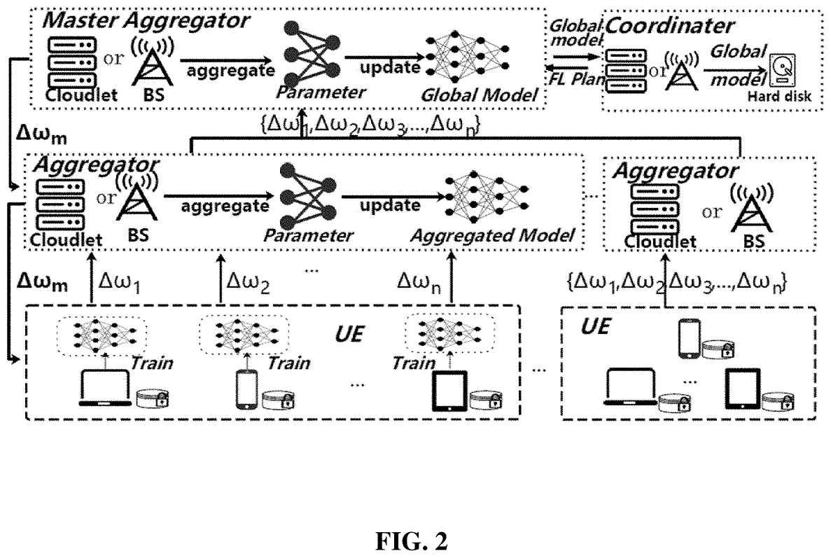

FIG. 2 is a schematic view of an FL framework provided by the present disclosure. As shown in FIG. 2, the FL framework is of a hierarchical structure composed of a master aggregator and multiple aggregators, and is intended to acquire trained models from UEs. One FL service typically involves multiple rounds of training and parameter aggregation. In each round of FL service, each UE trains local data according to model parameters and sends updated model parameters to the aggregator. Each aggregator acquires trained parameters from the UE. The master aggregator acquires a global model by aggregating data from all aggregators, and sends an updated global model to all UEs, for a next round of local training.

The uncertainty-aware FL method in an MEC network provided by the present disclosure implements the above technical solutions with three algorithms, namely: FWK, ApproAG and HeuAG.

The FWK obtains the number of aggregators with a binary search under an assumption that a size |wₘ| of the model parameter in each FL request is given, achieves a cost with UE assignment and aggregator placement that are obtained by the ApproAG and further uses the cost to change the number of aggregators to be calculated.

The ApproAG is an offline algorithm that makes decisions for the UE assignment and the aggregator placement according to the number of aggregators from the FWK under the condition that the size of the transmitted model parameter is known.

The HeuAG estimates a size of one model parameter under the condition that the size of the transmitted model parameter is uncertain (i.e., the network uncertainty), and implements each arrived FL request with an online algorithm based on a multi-armed bandit and the FWK.

At least some of the technical solutions of the present disclosure are implemented by defining an average volume of a training parameter of each UE under an uncertainty of an MEC network with the HeuAG, determining an average model size factor, and determining the minimum number of aggregators and the maximum number of aggregators; obtaining, by taking the determined minimum number of aggregators and the maximum number of aggregators as a known minimum number of aggregators and the maximum number of aggregators in the FWK, the number of aggregators with the FWK, and determining a location decision according to the number of aggregators by calling the ApproAG; determining a total cost during each FL task request according to the aggregator placement and UE assignment decision with the number of aggregators by calling the FWK; and adjusting the number of aggregators according to the total cost with a resource capacity of the MEC network as a constraint to generate the optimal number of aggregators during each FL task request, and optimizing an FL framework according to the optimal number of aggregators, thereby minimizing, or at least reducing, the total cost.

Three algorithms used in the present disclosure are described below:

### 1) FWK: Optimization Framework for Finding the Appropriate Number of Aggregators for Each FL Task Request.

The number of aggregators in one FL request plays a role in minimization, or at least reduction, of the implementation cost. More specifically, if more aggregators are used in one FL request, the aggregators can be distributed to locations closer to the UEs, thereby reducing the cost of updating the training parameters from the UEs to the aggregators. However, this can increase an amount of data transmitted from the aggregators to the server in one FL request to accelerate the communication cost of the aggregators to the server.

To find the appropriate number of aggregators for each FL request, the binary research is used. Apparently, each FL request requires at least one aggregator. The maximum number of aggregators instantiated in the MEC can depend on available resources on each location. Considering that one 5G MEC G=(BS∪CL, E) and the network is composed of a set of small-cell base stations and a set of cloudlets, n^{min} and n^{max} are defined as the minimum number and maximum number of aggregators for each FL request, respectively. The n^{min} has a minimal value of 1, which means that all training data of the UEs are aggregated by a single aggregator, but these parameter data cannot be aggregated due to insufficient available resources on this location.

The n^{min} is defined as:

$${n}^{min} = max \{ 1 , \frac{{γ}_{q} \cdot \vert {w}_{m} \vert \cdot \vert {με}_{m} \vert}{max \{ {C}_{q} \vert ∀ {Loc}_{q} \}} , \frac{{δ}_{q} \cdot \vert {w}_{m} \vert \cdot \vert {με}_{m} \vert}{max \{ {B}_{q} \vert ∀ {Loc}_{q} \}} \} \qquad ( 1 )$$

where, γ_{q} is a quantity of computing resources assigned to aggregate a unit data volume on the location Loc_{q}, wₘ is a size of a transmission model between a UE and an FL service m thereof, μεₘ is a UE set of the FL service m, δ_{q} is a quantity of bandwidth resources assigned to transmit unit data on the location Loc_{q}, B_{q} is a bandwidth resource capacity on the location Loc_{q}, and Loc_{q} is one potential location of the CL or the BS.

In the worst condition, each aggregator aggregates data of the single UE, i.e., the n^{max} is:

n^{max}=|μεₘ| (2)

An element array where each element is an integer value within [n^{min}, n^{max}] in an ascending order based on the value is considered. ń^{min} and ń^{max} are defined as a minimal value and a maximal value within a present range, cost(n) is a cost of the FL using n aggregators, and initially, n^{min}=ń^{min}, n^{max}=ń^{max} and the present range is an ever-changing range during the binary search.

[n^{min}, n^{max}] is obtained as follows:
cₖ^{unit} is defined as a calculation cost consumed by a UE ueₖ to train unit data, then the calculation cost cₖ^{l} of the UE ueₖ for locally training a dataset dsₖ is:

cₖ^{l}=cₖ^{unit}·|dsₖ|.

c_{k,q,i}^{t} is defined as a cost that the UE ueₖ transmits a unit data volume from a BS bsᵢ to a location Loc_{q}, x_{m,o,q} represents a binary variable on whether an aggregator A_{m,o} is placed on the Loc_{q}, and z_{k,i} represents whether the UE ueₖ is accessed to the MEC network through the BS bsᵢ, then the communication cost c_{k,m,o}^{t} of uploading of the UE ueₖ to one aggregator A_{m,o} in the service Sₘ is: c_{k,m,o}^{t}=Σ_{Loc′}_{_{q}}_{∈BS∪CL}Σ_{bs}_{ᵢ}_{∈BS}|wₘ|·c_{k,q,i}^{t}·x_{m,o,q}·z_{k,i}.

y_{m,q} is defined as a binary variable on whether the service Sₘ is placed to the Loc_{q}, and c_{q,\acute{q}}^{t} represents a cost for transmitting the unit data volume from the location Loc_{q} to the location Loc′_{q}, then the communication cost c_{m,o}^{t} for transmitting the model from one aggregator to the master aggregator in the service Sₘ is: c_{m,o}^{t}=Σ_{Loc}_{_{q}}_{,Loc}_{_{q′}}_{ΣBS∪CL}|wₘ|·x_{m,o,q}·y_{m,\grave{q}}·c_{q,\grave{q}}^{t}.

Hₘ is defined as a deployed aggregator set of the FL request rₘ, and α_{q} represents a cost for aggregating the training parameters of the UE on the location Loc_{q}, then the cost cₘ^{a} for aggregating the parameters for the FL request rₘ is: cₘ^{a}=Σ_{Loc}_{_{q}}_{∈BS∪CL}ρ_{A}_{_{m,o}}_{∈H}_{ₘ}x_{m,o,q}·α_{q}·Hₘ

Therefore, the cost cost(n) of the FL process using the n aggregators is

cost(n)=cₖ^{l}+n·c_{k,m,o}^{t}+n·c_{m,o}^{t}+cₘ^{a} (3)

In view of this, the optimization framework for finding the appropriate number of aggregators for each FL task request has the following process:

Set nₘᵢₙ and nₘₐₓ according to Eqs. (1) and (2).

When

$$cost ( {{n}^{′}}^{min} ) < cost ( {{n}^{′}}^{max} ) : {n}_{m} ← ⌈ \frac{{{n}^{′}}^{min} + {{n}^{′}}^{max}}{2} ⌉ .$$

Obtain aggregator placement and UE assignment by calling the

ApproAG, and substitute them into Eq. (3) to obtain the cost(nₘ).

Calculate cost(ń^{min}) and cost(ń^{max}), until cost (ń^{min})≥cost(ń^{max})

If cost(nₘ)≤cost(ń^{min}) , then ń^{min}←nₘ; or otherwise, ń^{max}←nₘ.

### 2) ApproAG: Algorithm for Aggregator Placement and UE Assignment in the FL Task.

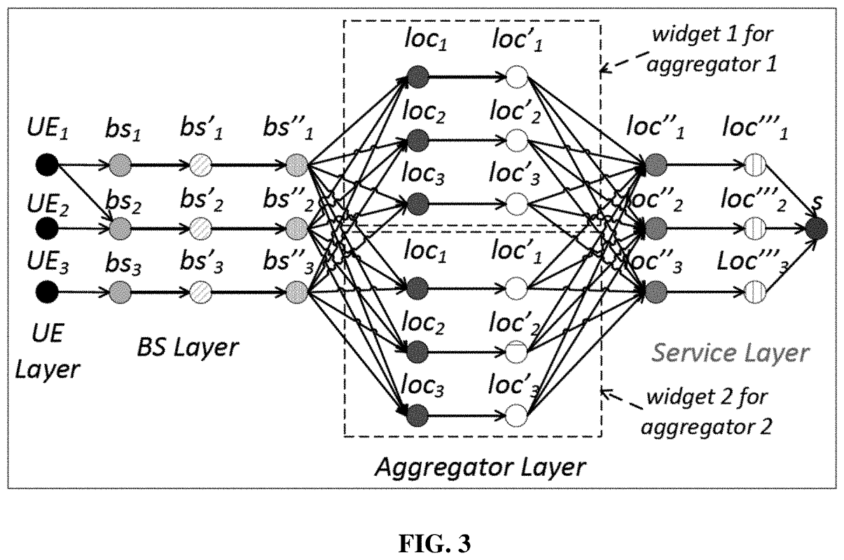

The combined problem of aggregator placement and UE assignment for a single FL request in the MEC network is simplified as a minimum-cost multi-commodity flow problem. In other words, the training parameter of each UE is viewed as a commodity, and there is a source ueₖ, a sink node s and a demand size |wₘ|. The auxiliary graph \grave{G} as shown in FIG. 3 can be constructed according to the number of aggregators obtained with the FWK framework. After the number of aggregators is obtained, the aggregator placement and relevant UE assignment can be considered. In the auxiliary graph \grave{G}, the commodities are routed from ueₖ to s. In order to route the commodities of the UEs to their sink node s, a splittable multi-commodity flow of each UE to s is found in \grave{G}. fₖ is set as a flow obtained by the UE ueₖ, where fₖ can be split into different paths of the auxiliary graph \grave{G}. With the use of a Randomized rounding method, the obtained flow is converted into probabilities for the association between the UE ueₖ and the BS, the aggregator placement, and the service placement of each FL request.

First, the probability of association between the UE ueₖ and the BS bsᵢ is calculated: On the BS layer, fₖ(bsᵢ) represents a flow passing through edges <bsᵢ,bśᵢ> and <bśᵢ, bs″ᵢ>. The probability p_{k,i} of association between the UE ueₖ and the BS bsᵢ is:

$${p}_{k , i} = \frac{{f}_{k} ( {bs}_{i} )}{2 \cdot {f}_{k}} \qquad ( 4 )$$

Next, the probability that one aggregator A_{m,o} is placed to the Loc_{q} is calculated: Each A_{m,o} in the \grave{G} includes a widget composed of potential locations thereof. W_{m,o} is defined as the widget of the aggregator A_{m,o}, and fₖ(Loc_{q}, W_{m,o}) represents a flow routed by the widget W_{m,o} through the edge <Loc_{q}, Loc′_{q}>. The probability p_{m,o,q} that the aggregator A_{m,o} is placed to the Loc_{q} is:

$${p}_{m , o , q} = \frac{{\sum }_{{ue}_{k} ∈ UE} {f}_{k} ( {Loc}_{q} , {W}_{m , o} )}{2 \cdot {\sum }_{{Loc}_{{q}^{′}} ∈ BS ⋃ CL , {ue}_{k} ∈ UE} {f}_{k} ( {Loc}_{{q}^{′}} , {W}_{m , o} )} \qquad ( 5 )$$

The principle lies in: The edge on which more flows are routed by the widget is more likely to become a location for the A_{m,o}. Thirdly, according to the number of flows routed by each edge on the service layer of the auxiliary graph \grave{G}, the probability that the service Sₘ is placed to the location Loc_{q} is calculated. Similar to the calculation of the probability of the aggregator layer, fₖ (Loc_{q}, Sₘ) represents a flow routed through an edge <Loc″_{q}, Loc′″_{q}>, |wₘₐₓ| represents a maximal value of the size of the transmission model, and dᵤₙᵢₜ represents a data unit smaller than the size |wₘₐₓ| of the transmission model. The probability p_{m,q} that the service Sₘ is placed to the location Loc_{q} is:

$${p}_{m , q} = \frac{{\sum }_{{ue}_{k} ∈ UE} {f}_{k} ( {Loc}_{q} , {S}_{m} )}{2 \frac{\vert {w}_{max} \vert}{{d}_{unit}} \cdot {\sum }_{L o {c}_{{q}^{′}} ∈ BS ⋃ CL , {ue}_{k} ∈ UE} {f}_{k} ( {Loc}_{{q}^{′}} , {S}_{m} )} \qquad ( 6 )$$

In view of this, the ApproAG includes the following steps:

Construct the auxiliary graph \grave{G}, and correspondingly set a cost and a capacity of each edge.

Take the training parameter of each UE as a demanded commodity.

Find a splittable flow from a source ueₖ to a sink node s for each UE from the constructed auxiliary graph \grave{G}.

Respectively calculate a probability p_{k,i} that the UE is assigned to the BS, a probability p_{m,o,q} that the aggregator is placed to the location Loc_{q} and a probability p_{m,q} that the service is placed to the location Loc_{q} according to Eqs. (4), (5) and (6).

Randomly assign the UE ueₖ to the BS bsᵢ according to the probability p_{k,i}, randomly place each aggregator nₘ on the location Loc_{q} according to the probability p_{m,o,q}, and randomly place the service Sₘ on the location Loc_{q} according to the probability p_{m,q}.

Based on the above initial FL training framework, e.g., there are the corresponding aggregators and the locations for placing the aggregators for the selected UEs, the following steps are performed on each UE ueₖ to find the optimal UE assignment and aggregator placement:

Move each splittable flow of fₖ to a randomly selected BS on a UE and BS layer of the auxiliary graph \grave{G}.

Move each splittable flow of fₖ to a minimum-cost aggregator on the aggregator layer of the auxiliary graph \grave{G}.

Move, on a service layer of the auxiliary graph \grave{G}, each splittable flow of fₖ to a location where the service is located.

Convert an unsplittable flow \grave{f} obtained into the decision for UE assignment, aggregator placement and service placement.

A node path through which the unsplittable flow \grave{f} passes is a decision-making result for the UE assignment, the aggregator placement and the service placement.

Applications:

The above three decisions must be known to calculate the cost in the FWK, thereby calculating the cost (consumption of the computing resources and communication resources) of the UEs, the cost of the aggregators, etc. For example, according to the UE assignment, the corresponding cost of each assigned UE can be calculated. Then, the number of the aggregators are obtained with the binary search according to the cost.

With the application of the above three decisions, the whole FL task request can be completed under the condition of limited resources.

3) HeuAG: Online Algorithm for Implementing Each Arrived FL Task Request under the Network Uncertainty.

Since the data volume of the UEs and the size of the learning model parameter are uncertain, it is challenging to accurately implement the FL in the MEC network. The algorithm is a novel online learning algorithm based on the MAB and is intended to implement each arrived FL request under the condition that the data volume of the UEs and the size of the learning model parameter are uncertain. The basic concept is to give the model size of each FL request with the optimization framework proposed by the FWK. In the FWK, it is assumed that the model size |wₘ| of each FL request is given. If the model size is uncertain, each FL request can be implemented according to an average model size.

μ(|wₘ|) is defined as an average volume of the training parameter of each UE ueₖ, such that a few modifications can be made on the FWK framework. The minimum number n^{min} of aggregators is calculated according to μ(|wₘ|) rather |wₘ|. The demand for each commodity in the ApproAG is considered as |wₘ|. However, the actual model size is far more than the average size to result in that the resource capacity on some location in the MEC network is seriously exceeded. In order to avoid the serious resource conflict, the average model size of each FL request is amplified to a factor indicated as χ, χ being a true value in [1, |wₘₐₓ|/μ(|wₘ|)]. Specifically, n^{min} in the FWK is calculated as:

$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ {Loc}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ {Loc}_{q} \}} \} \qquad ( 7 )$$

It is to be noted that the n^{min} is calculated in Eq. (1) with the pre-known model size, but is calculated in Eq. (7) under the network uncertainty, i.e., the model size is estimated from the factor indicated as the χ.

In addition, it is considered that each commodity of the UE ueₖ in the FL request has such a demand size:

(1+χ)·μ(|wₘ|)/dᵤₙᵢₜ (8)

The key problem is how to determine the value of the χ. the χ uses a fixed value and requests entering the system are optimized once for all. In other words, since the distribution of the model sizes of the requests is known, the probability of the ApproAG may be pre-calculated with one-time optimization. Upon the arrival of each request, the UEs are randomly assigned, and the aggregators and the services are randomly placed according to the pre-calculated probability. However, if the actual model size of each request is obviously deviated from the anticipated model size, the algorithm can be far from satisfactory in performance. In order to avoid such a case, the value of the χ is adaptively learnt through the self-defined resize algorithm.

To find an approximate value of the χ more effectively, the range of the χ is discretized into ζ intervals, each of which has a length of len=(|wₘₐₓ|.|wₘᵢₙ|−1)/ζ, thereby obtaining a set of finite values of the χ: val={1+(i−1)·len|1≤i≤ζ}. By finding the value in val adaptively and adopting an activation and selection scheme of keeping a set of active values for χ, the minimum cost of the problem can be implemented. The val is defined as an active value set of χ, and each active value is activated and selected to minimize the cost of the problem. It is evident that val\grave{ }⊆val, val being a set of the discretized finite values of χ.

One value in val is put into the set val′ once activated. It is observed that χ values slightly different can have the similar costs to implement the FL request rₘ, and activation of these values with similar costs will reduce the efficiency of the algorithm. Hence, a confidence radius is defined for each value v∈val\grave{ }, such that the value v\grave{ } in val rather than the confidence radius of v is activated to the set val\grave{ }. With regard to the value v and the presently arrived request rₘ, numₐ(v) represents the number of requests before the request rₘ selects v as the χ value, u_{c}(v) represents an average cost obtained by the algorithm in the process of selecting the number numₐ(v) of times for v, and R represents the number of requests. Therefore, the confidence radius is defined as radiusᵥ={square root over (2R/(numₐ(v)+1))}.

Each value in val\grave{ } serves as one arm, the arm radius is the confidence radius of the value, and the arm in val\grave{ } represents the value in val. Ideally, the arm radius of val\grave{ } should cover all values in val. Each value has a large covering radius before selected. Upon arrival of the request to the system, the confidence region of each value is narrowed, such that some values are not covered. In order to keep the arm of val\grave{ } to cover all values in val, these uncovered values are directly added to val\grave{ }. After a set of movable arms are obtained, one arm will be selected from val\grave{ } upon the arrival of each FL request. Ideally, it is expected to select one arm that can reduce the cost and include more values in val. The arms in val\grave{ } are sorted in a descending order according to 1/u_{c}(v)+2·radiusᵥ, such that these arms having the arm radius and capable of covering all values in val are selected. For example, there are 10 points (equivalent to the finite value set val) in total, and three points (equivalent to the active value set val\grave{ }) selected therefrom are equivalent to the arms; and each arm has its length (equivalent to drawing a circle with this point as a center and the arm radius as a radius) and the three circles may include the 10 points.

Objective: χ values (estimated model sizes) slightly different can have the similar cost during implementation of the FL request rₘ (equivalent to selecting the value one by one from val, i.e., the 10 points are selected one by one and 10 extra costs are generated). As activation of these values with the similar costs will reduce the efficiency of the algorithm, the active values are activated and selected (i.e., only three points are searched in val\grave{ }) to minimize the cost of the problem.

In view of this, the HeuAG specifically includes the following steps:

Discrete a range of the average model size χ transmitted during the FL into ζ intervals of a fixed length.

Set val as a finite value set of χ.

val\grave{ }←∅, the value of /*val\grave{ } being/* selected from val.

Select some values in val greedily by using a greedy algorithm of an MAB, where these values may be all values covered by the radius in val and added to val\grave{ }.

The following steps are performed on each arrived FL request:

Select a value having the highest level of 1/u_{c}(v)+2·radiusᵥ from val\grave{ }.

Call the FWK, set n^{min} according to Eq. (7), and set a demand of each commodity according to Eq. (8), where, the value of val\grave{ } is the estimated average model size μ|wₘ|, and for the uncertain transmission model size, n^{min} demand for each commodity (model parameter size |wₘ|) of each UE) can be calculated by selecting one value from val\grave{ }, and the FL request is implemented by calling the FWK.

Update the number of selections on each value in val\grave{ } through each value in val\grave{ } and the confidence radius.

If a value (the value of val) is not within val\grave{ }, add the uncovered value to val\grave{ }.

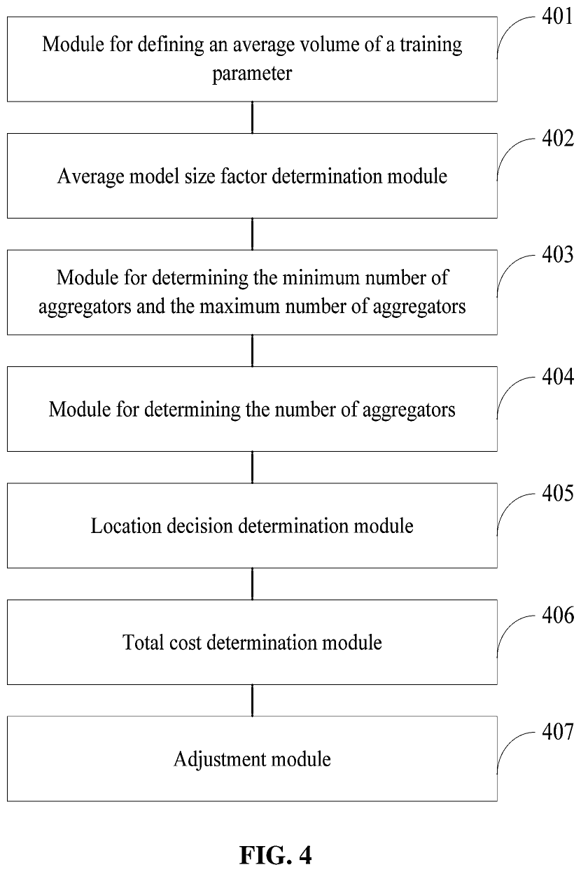

FIG. 4 is a structural view of an uncertainty-aware FL system in an MEC network according to the present disclosure. As shown in FIG. 4, the uncertainty-aware FL system in an MEC network includes: module 401 for defining an average volume of a training parameter, average model size factor determination module 402, module 403 for determining the minimum number of aggregators and the maximum number of aggregators, module 404 for determining the number of aggregators, location decision determination module 405, total cost determination module 406 and adjustment module 407.

Module 401 for defining an average volume of a training parameter is configured to define an average volume of a training parameter of each UE under an uncertainty of an MEC network based on an FL framework, the uncertainty of the MEC network being an uncertainty of a transmitted model parameter.

The average model size factor determination module 402 is configured to determine an average model size factor during each FL task request according to the average volume of the training parameter of each UE.

The average model size factor determination module 402 can specifically include: a discretization unit configured to discretize a range of the average model size factor into any interval of a fixed length according to the average volume of the training parameter of each UE; a finite value set determination unit configured to determine a finite value set of the average model size factor according to the fixed length; an active value set determination unit configured to determine an active value set of the average model size factor according to the finite value set by using a greedy algorithm of an MAB; and an average model size factor determination unit configured to determine the average model size factor according to the active value set.

Module 403 for determining the minimum number of aggregators and the maximum number of aggregators is configured to determine the minimum number of aggregators and the maximum number of aggregators during each FL task request according to the average model size factor.

Module 403 for determining the minimum number of aggregators and the maximum number of aggregators can specifically include: a unit for determining the minimum number of aggregators configured to determine the minimum number of aggregators with

$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ {Loc}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ {Loc}_{q} \}} \} ,$$

where, n^{min} is the minimum number of aggregators; γ_{q} is a quantity of computing resources assigned to aggregate a unit data volume on the location Loc_{q}; χ is the average model size factor; μ(|wₘ|) is the average volume of the training parameters of each UE; |wₘ| is a size of a transmission model between the UE and its service Sₘ; μεₘ is a UE set of the FL service m; Loc_{q} is one first potential location of a CL or a BS; Cq is a computing resource capacity on the location Loc_{q}; δ_{q} is a quantity of bandwidth resources assigned to transmit unit data on the location Loc_{q}; and B_{q} is a bandwidth resource capacity on the location Loc_{q}; and a unit for determining the maximum number of aggregators configured to acquire the number of UEs.

Module 404 for determining the number of aggregators is configured to determine the number of aggregators according to the minimum number of aggregators and the maximum number of aggregators.

The location decision determination module 405 is configured to construct an auxiliary graph according to the number of aggregators, and determine a location decision according to the auxiliary graph, the location decision including UE assignment, aggregator placement and service placement.

The total cost determination module 406 is configured to determine a total cost during each FL task request according to the aggregator placement and UE assignment decision with the number of aggregators.

The adjustment module 407 is configured to adjust the number of aggregators according to the total cost with a resource capacity of the MEC network as a constraint to obtain the decision including aggregator placement and UE assignment and the optimal number of aggregators during each FL task request, and optimize the FL framework according to the optimal number of aggregators, thereby minimizing, or at least reducing, the total cost.

For the combined problem on aggregator placement and UE assignment during the single FL in the MEC network, the present disclosure minimizes the implementation cost with a resource capacity of the MEC network as a constraint. The present disclosure provides the optimization framework to find the appropriate number of aggregators for each FL request and provides the approximation algorithm that has the provable approximation ratio for the defined problem. In view of the uncertainties on the data volume of each UE and the learning parameter size in the request of each UE, as well as the problems on the UE assignment and the online aggregator placement in the MEC network having multiple FL requests, the present disclosure provides a novel online learning algorithm based on the MAB. The performance of the algorithm is evaluated according to existing research. Experimental results reveal that the proposed algorithm outperforms the similar algorithms in performance and reduces the implementation cost by at least 15%.

Each embodiment of the present specification is described in a progressive manner, each embodiment focuses on the difference from other embodiments, and the same and similar parts between the embodiments may refer to each other. Since the system disclosed in the embodiments corresponds to the method disclosed in the embodiments, the description is relatively simple, and reference can be made to the method description.

In this specification, several specific embodiments are used for illustration of the principles and implementations of the present disclosure. The description of the foregoing embodiments is used to help illustrate the method of the present disclosure and the core ideas thereof. In addition, those of ordinary skill in the art can make various modifications in terms of specific implementations and the scope of application in accordance with the ideas of the present disclosure. In conclusion, the content of this specification shall not be construed as a limitation to the present disclosure.

What is claimed is:

1. An uncertainty-aware federated learning (FL) method in a mobile edge computing (MEC) network, comprising:
defining an average volume of a training parameter of each user equipment (UE) under an uncertainty of an MEC network based on an FL framework, the uncertainty of the MEC network being an uncertainty of a transmitted model parameter;
determining an average model size factor during each FL task request according to the average volume of the training parameter of each UE;
determining a minimum number of aggregators and a maximum number of aggregators during each FL task request according to the average model size factor;
determining a number of aggregators according to the minimum number of aggregators and the maximum number of aggregators;
constructing an auxiliary graph according to the number of aggregators, and determining a location decision according to the auxiliary graph, the location decision comprising UE assignment, aggregator placement and service placement;
determining a total cost during each FL task request according to the aggregator placement and UE assignment decision with the number of aggregators; and
adjusting the number of aggregators according to the total cost with a resource capacity of the MEC network as a constraint to obtain the decision including aggregator placement and UE assignment and an optimal number of aggregators during each FL task request, and optimizing the FL framework according to the optimal number of aggregators, thereby minimizing, or at least reducing, the total cost.

2. The uncertainty-aware FL method in an MEC network according to claim 1, wherein the determining an average model size factor during each FL task request according to the average volume of the training parameter of each UE specifically comprises:
discretizing a range of the average model size factor into any interval of a fixed length according to the average volume of the training parameter of each UE;
determining a finite value set of the average model size factor according to the fixed length;
determining an active value set of the average model size factor according to the finite value set by using a greedy algorithm of a multi-armed bandit (MAB); and
determining the average model size factor according to the active value set.

3. The uncertainty-aware FL method in an MEC network according to claim 1, wherein the determining the minimum number of aggregators and the maximum number of aggregators during each FL task request according to the average model size factor specifically comprises:
determining the minimum number of aggregators with
$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ {Loc}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ {Loc}_{q} \}} \} ,$$
wherein, n^{min} is the minimum number of aggregators; γ_{q} is a quantity of computing resources assigned to aggregate a unit data volume on a location Loc_{q}; χ is the average model size factor;
μ(|wₘ|) is the average volume of the training parameter of each UE;

|wₘ| is a size of a transmission model between the UE and its service Sₘ;
μεₘ is a UE set of a FL service m;
Loc_{q} is one first potential location of a cloudlet (CL) or a base station (BS);
Cq is a computing resource capacity on the location Loc_{q}; δ_{q} is a quantity of bandwidth resources assigned to transmit unit data on the location Loc_{q}; and
B_{q} is a bandwidth resource capacity on the location Loc_{q}.

4. The uncertainty-aware FL method in an MEC network according to claim 1, wherein the determining the number of aggregators according to the minimum number of aggregators and the maximum number of aggregators specifically comprises:
determining the number of aggregators within a present range according to the minimum number of aggregators and the maximum number of aggregators by using a binary search, the present range being an ever-changing range during the binary research.

5. The uncertainty-aware FL method in an MEC network according to claim 1, wherein the constructing an auxiliary graph according to the number of aggregators, and determining a location decision according to the auxiliary graph specifically comprises:
constructing the auxiliary graph according to the number of aggregators, and setting a cost and a capacity of each edge within the auxiliary graph;
taking the training parameter of each UE as a demanded commodity, and determining a demand for commodities of training parameters in each FL request according to the average model size factor;
determining a splittable flow from a source to a sink node for each UE from the auxiliary graph based on the demand for the commodities, the splittable flow being a multi-commodity flow;
determining, according to the splittable flow, a probability that the UE is assigned to the BS, a probability that the aggregator is placed to a Loc_{q} and a probability that the service is placed to the Loc_{q}, the Loc_{q} being the first potential location of the CL or the BS;
determining, according to the probability that the UE is assigned to the BS, the probability that the aggregator is placed to the Loc_{q} and the probability that the service is placed to the Loc_{q}, a location where the UE is randomly assigned to the BS, a location where the aggregator is randomly placed to the Loc_{q} and a location where the service is randomly placed;
moving, according to the location where the UE is randomly assigned to the BS, each splittable flow of the UE to a randomly selected BS on a UE and BS layer of the auxiliary graph;
moving, according to the location where the aggregator is randomly placed to the Loc_{q}, each splittable flow of the UE to a minimum-cost aggregator on a aggregator layer of the auxiliary graph;
moving, according to the location where the service is randomly placed, on a service layer of the auxiliary graph, each splittable flow of the UE to a location where the service is located; and
determining an unsplittable flow according to the splittable flow, and converting the unsplittable flow into the location decision comprising the UE assignment, the aggregator placement and the service placement, a node path through which the unsplittable flow passes being a decision-making result of the location decision.

6. The uncertainty-aware FL method in an MEC network according to claim 5, wherein the probability that the UE is assigned to the BS is:
$${p}_{k , i} = \frac{{f}_{k} ( {bs}_{i} )}{2 \cdot {f}_{k}}$$
wherein, p_{k,i} is the probability that the UE is assigned to the BS; fₖ(bsᵢ) is a flow passing through an edge between the UE and the BS on the UE and BS layer of the auxiliary graph; and fₖ is the flow obtained by the UE;
the aggregator layer provides a potential location of the aggregator for the FL request; nₘ widgets W_{m,o} are created, with each widget corresponding to a potential location set of an aggregator A_{m,o}; a potential location having a sufficient available resource is added to a widget W_{m,0} to complete an aggregation task of the aggregator A_{m,o}; and a second potential location Loc′_{q} is created, the second potential location Loc′_{q} being a virtual location node, and the Loc′_{q} and the Loc_{q} are added to a widget together;
the probability that the aggregator is placed to the Loc_{q} is:
$${p}_{m , o , q} = \frac{{\sum }_{{ue}_{k} ∈ UE} {f}_{k} ( {Loc}_{q} , {W}_{m , o} )}{2 \cdot {\sum }_{{Loc}_{{q}^{′}} ∈ BS ⋃ CL , {ue}_{k} ∈ UE} {f}_{k} ( {Loc}_{{q}^{′}} , {W}_{m , o} )}$$
wherein, p_{m,o,q} is the probability that the aggregator is placed to the Loc_{q}; ueₖ is any UE; all UEs are collectively called the UE; W_{m,o} is the widget of the aggregator A_{m,o}; Loc_{q′} is the second potential location; BS is a set of small-cell base stations; CL is a set of cloudlets; fₖ(Loc_{q},W_{m,o}) is a flow routed by the widget W_{m,o} through an edge <Loc_{q},Loc′_{m,o}> in the auxiliary graph; Σᵤₑ_{ₖ}_{∈UE}fk(Loc_{q}, W_{m,o}) is a total routing flow of the widget W_{m,o} placed on one Loc_{q} location through the aggregator A_{m,o}; and Σ_{Loc′}_{_{q}}_{∈BS∪CL,ue}_{ₖ}_{∈UE}fₖ(Loc_{q′}, W_{m,o}) is a total routing flow of the widget W_{m,o} placed on all potential locations through the aggregator A_{m,o};
the service layer provides two virtual nodes Loc″_{q} and Loc′″_{q} for each first potential location Loc_{q} and service Sₘ, the Loc″_{q} being a third potential location, and the LOC″′_{q} being a fourth potential location; and every two Loc″_{q} and Loc′″_{q} are added to a new widget for the service Sₘ; and
the probability that the service placed to the Loc_{q} is:
$${p}_{m , q} = \frac{{\sum }_{{ue}_{k} ∈ UE} {f}_{k} ( {Loc}_{q} , {S}_{m} )}{2 \frac{\vert {w}_{max} \vert}{{d}_{unit}} \cdot {\sum }_{L o {c}_{{q}^{′}} ∈ BS ⋃ CL , {ue}_{k} ∈ UE} {f}_{k} ( {Loc}_{{q}^{′}} , {S}_{m} )}$$
wherein, p_{m,q} is the probability that the service is placed to Loc_{q}; fₖ(Loc_{q}, Sₘ) is a flow routed through an edge <Loc″_{q},Loc′″_{q}> in the auxiliary graph; Σᵤₑ_{ₖ}_{∈UE}fₖ(Loc_{w}, Sₘ) is a total routing flow of placement on one Loc_{q} location through the service Sₘ; and Σ_{Loc′}_{_{q}}_{∈BS∪CL,ue}_{ₖ}_{∈UE}fₖ(Loc_{q′}, Sₘ) is a total routing flow of placement on all potential locations through the service Sₘ .

7. The uncertainty-aware FL method in an MEC network according to claim 6, wherein the determining a total cost during each FL task request according to the aggregator placement and UE assignment decision with the number of aggregators specifically comprises:
determining the total cost during each FL task request with an Eq. cost(n)=cₖ^{l}+n·c_{k,m,o}^{t}+n·c_{m,o}^{t}+cₘ^{a}, wherein, cost(n) is the total cost during the FL task request using n aggregators, n being the number of aggregators; cₖ^{l} is a calculation cost of the UE for locally training a dataset; c_{k,m,o}^{t} is a communication cost of uploading of a UE ueₖ to one aggregator A_{m,o} in the service Sₘ; c_{m,o}^{t} is a communication cost for uploading a model from one aggregator to a master aggregator in the service Sₘ; and cₘ^{a} is a cost of parameter aggregation during the FL task request.

8. An uncertainty-aware federated learning (FL) system in a mobile edge computing (MEC) network, comprising:
a module for defining an average volume of a training parameter configured to define an average volume of a training parameter of each user equipment (UE) under an uncertainty of an MEC network based on an FL framework, the uncertainty of the MEC network being an uncertainty of a transmitted model parameter;
an average model size factor determination module configured to determine an average model size factor during each FL task request according to the average volume of the training parameter of each UE;
a module for determining a minimum number of aggregators and a maximum number of aggregators configured to determine the minimum number of aggregators and the maximum number of aggregators during each FL task request according to the average model size factor;
a module for determining a number of aggregators configured to determine the number of aggregators according to the minimum number of aggregators and the maximum number of aggregators;
a location decision determination module configured to construct an auxiliary graph according to the number of aggregators, and determine a location decision according to the auxiliary graph, the location decision comprising UE assignment, aggregator placement and service placement;
a total cost determination module configured to determine a total cost during each FL task request according to the location decision and the number of aggregators; and
an adjustment module configured to adjust the number of aggregators according to the total cost with a resource capacity of the MEC network as a constraint to obtain the decision including aggregator placement and UE assignment and an optimal number of aggregators during each FL task request, and optimize the FL framework according to the optimal number of aggregators, thereby minimizing, or at least reducing, the total cost.

9. The uncertainty-aware FL system in an MEC network according to claim 8, wherein the average model size factor determination module specifically comprises:
a discretization unit configured to discretize a range of the average model size factor into any interval of a fixed length according to the average volume of the training parameter of each UE;
a finite value set determination unit configured to determine a finite value set of the average model size factor according to the fixed length;
an active value set determination unit configured to determine an active value set of the average model size factor according to the finite value set by using a greedy algorithm of a multi-armed bandit (MAB); and
an average model size factor determination unit configured to determine the average model size factor according to the active value set.

10. The uncertainty-aware FL system in an MEC network according to claim 8, wherein the module for determining the minimum number of aggregators and the maximum number of aggregators specifically comprises:
a unit for determining the minimum number of aggregators configured to determine the minimum number of aggregators with
$${n}^{min} = max \{ 1 , \frac{{γ}_{q} \cdot ( 1 + χ ) \cdot μ ( \vert {w}_{m} \vert ) \cdot \vert {με}_{m} \vert}{max \{ {C}_{q} \vert ∀ {Loc}_{q} \}} , \frac{{δ}_{q} \cdot ( 1 + χ ) \cdot μ ( \vert {w}_{m} \vert ) \cdot \vert {με}_{m} \vert}{max \{ {B}_{q} \vert ∀ {Loc}_{q} \}} \} ,$$
wherein, n^{min} is the minimum number of aggregators; γ_{q} is a quantity of computing resources assigned to aggregate a unit data volume on a location Loc_{q}; χ is the average model size factor; μ(|wₘ|) is the average volume of the training parameter of each UE; |wₘ| is a size of a transmission model between the UE and its service Sₘ; μεₘ is a UE set of a FL service m; Loc_{q} is one first potential location of a cloudlet (CL) or a base station (BS); Cq is a computing resource capacity on the location Loc_{q}; δ_{q} is a quantity of bandwidth resources assigned to transmit unit data on the location Loc_{q}; and B_{q} is a bandwidth resource capacity on the location Loc_{q}; and
a unit for determining the maximum number of aggregators configured to acquire a number of UEs.
